(19) United States
(12) Patent Application Publication
(10) Pub. No.: US 2013/0200246 A1
(43) Pub. Date: Aug. 8, 2013

(54) Pole Support Structure

(71) Applicants: Wayne A. VanBenschoten, Ivoryton, CT (US); Michael J. Elmoznino, Lyme, CT (US); Michael J. Ferrara, Mystic, CT (US)

(72) Inventors: Wayne A. VanBenschoten, Ivoryton, CT (US); Michael J. Elmoznino, Lyme, CT (US); Michael J. Ferrara, Mystic, CT (US)

(73) Assignee: JAYPRO SPORTS, INC., Waterford, CT (US)

(21) Appl. No.: 13/364,734

(22) Filed: Feb. 2, 2012

(51) Int. Cl. F16M 11/42; F16M 11/22

(52) U.S. Cl. 248/519

(57) ABSTRACT

Apparatus are provided that include a pole having a first and second end with the pole being configured to support one or more gaming apparatus. A base is configured to support the pole to hold the pole in an upright position. The base has a front and back end, and is configured to receive the first end of the pole such that the pole is positioned closer to the front end than the back end of the base. The base has a center of gravity that is closer to the back end than the front end such that the back end provides lateral stability to the base. The base can also include one or more retractable wheels movable between a retracted position in which the base is fixed relative to a support surface, and an extended position in which the base is movable relative to the support surface.

### FIELD OF THE DISCLOSURE

Aspects of the present disclosure relate to a support structure for a pole, in particular a structure used for activities/game play.

### BACKGROUND

A game base is a device used for recreational activities, and has been a staple in gymnasiums where they have been used for a variety of game play. The game base typically consists of an upright pole positioned in a base. The upright pole can be used to hold equipment, such as a net, used for games such as volleyball, badminton, and tennis. Various other types of equipment, such as rims or tetherballs, can be attached to the game base and used for other types of game play as well.

Game bases are usually portable, allowing the device to be moved as needed when setting up a game environment or storing the device. To transport the base, it is tilted onto wheels that are attached to the base and can be pushed or pulled to the desired location. The movement of the base can come with safety hazards due to the heavy weight of the base and the need to tilt the base onto the wheels for movement along the floor. In addition, this method of moving the base can also put stress on the components of the game base itself as a user is required to pull on the upright pole to tilt and move the base. This can lead to fatigue of various components of the base, and in particular the components that hold the upright pole in the base.

### SUMMARY

In accordance with one aspect of the present disclosure, apparatus are provided that include a pole having a first end and a second end. The pole is configured to support one or more gaming apparatus. A base is configured to support the pole to hold the pole in an upright position. The base includes a front end and a back end. The base is configured to receive the first end of the pole such that the pole is positioned closer to the front end of the base than the back end of the base. The base has a center of gravity that is closer to the back end than the front end such that the back end of the base provides lateral stability to the base.

In accordance with another aspect of the present disclosure, apparatus are provided that include a base having a pole extending therefrom with the pole being configured to extend from the base in an upright position and to support one or more gaming apparatus. A first set of wheels extend from the base and are retractable between a retracted position in which the base is fixed relative to a support surface, and an extended position in which the base is movable relative to the support surface. A second set of wheels also extend from the base.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a side view of one embodiment of a pole support structure having a pole formed from a first and second pole;

FIG. 2 is a side view of the pole support structure of FIG. 1 with the second pole substantially inside the first pole to decrease the overall length of the pole;

FIG. 3 is a side view of the first and second poles of the pole support structure of FIG. 1;

FIG. 4 is a side view of one embodiment of a collar that can be coupled to the pole of the base of the pole support structure of FIG. 1;

FIG. 5 is a top view of a base of the pole support structure of FIG. 1;

FIG. 6 is a side view of the pole support structure of FIG. 1 having first and second retracted wheels moved into an extended position such that the pole support structure can move along a support surface;

FIG. 7 is a bottom perspective view of the pole support structure of FIG. 1 showing a base having first and second fixed wheels, and first and second retractable wheels in a retracted position;

FIG. 8 is a bottom perspective view of the base of FIG. 6 with the first and second retractable wheels in an extended position;

FIG. 9 is a side cross-sectional view of the base of FIG. 6 with the retractable wheels in the extended position;

FIG. 10 is a side cross-sectional view of the base of FIG. 6 with the retractable wheels in the retracted position;

FIG. 11A is a side view of one embodiment of an assembly and actuation mechanism of the retractable wheels;

FIG. 11B is a front view of the assembly and actuation mechanism of FIG. 11A;

FIG. 12A is a side view of another embodiment of an assembly and actuation mechanism of the retractable wheels;

FIG. 12B is a front view of the assembly and actuation mechanism of FIG. 12A;

FIG. 13 is side cross-sectional view of another embodiment of a pole support structure having one or more retractable feet in an extended position for stabilizing the pole support structure;

FIG. 14 is a side cross-sectional view of the pole support structure of FIG. 13 showing the retractable foot in a retracted position to allow the pole support structure to move along a support surface;

FIG. 15 is a side view of another embodiment of a base for a pole support structure; and

FIG. 16 is a side cross-sectional view of the base of FIG. 15.

### DETAILED DESCRIPTION

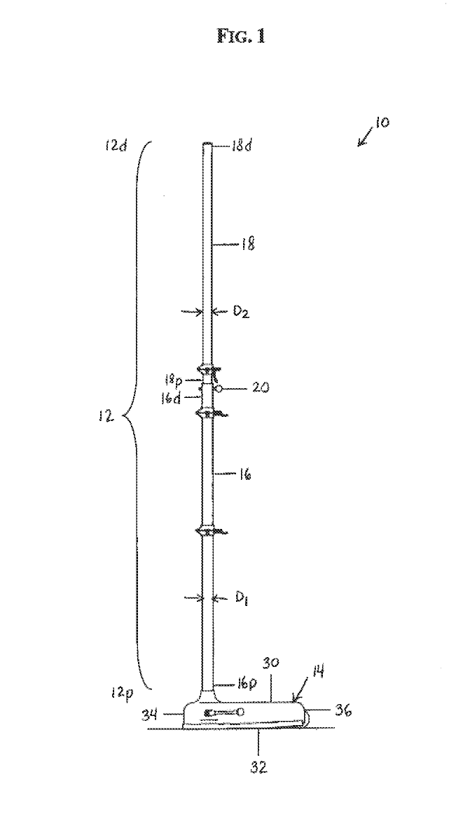

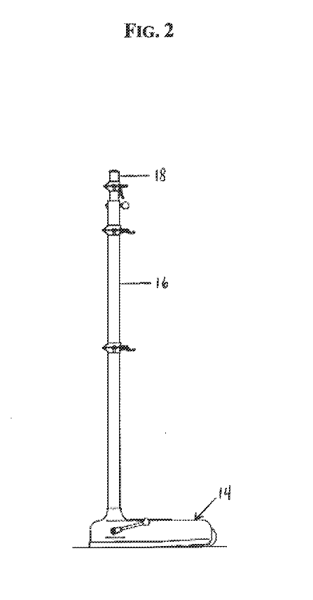

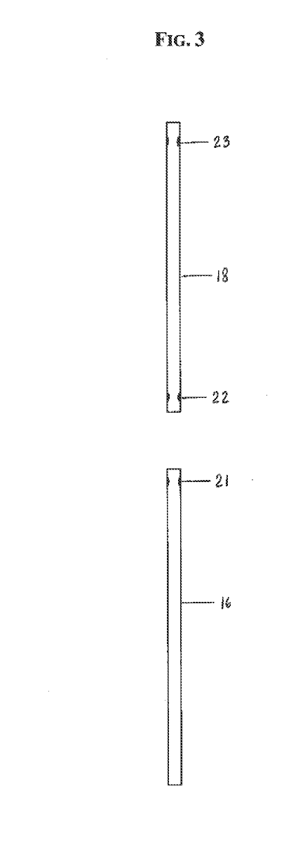

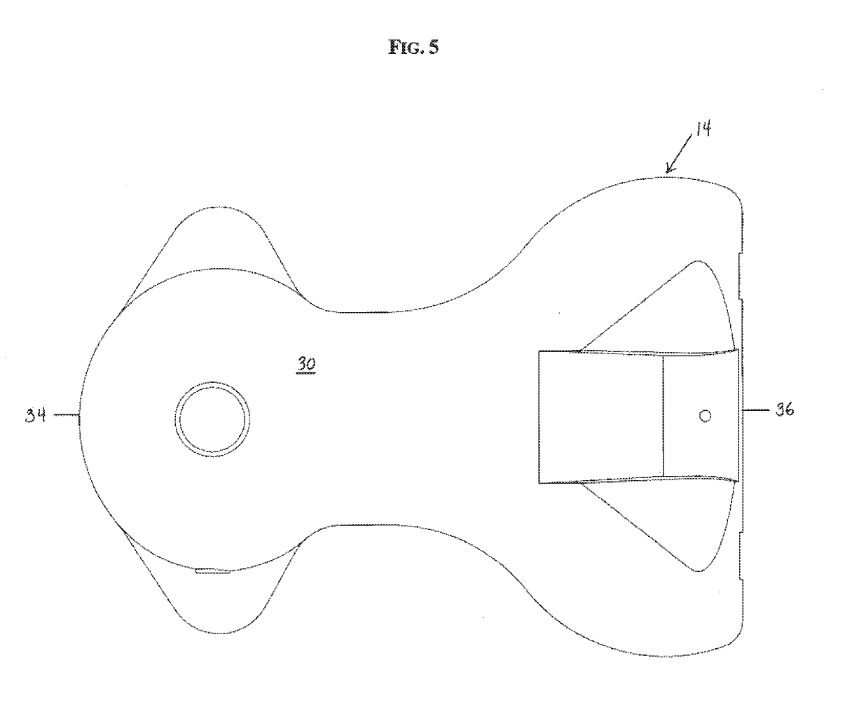

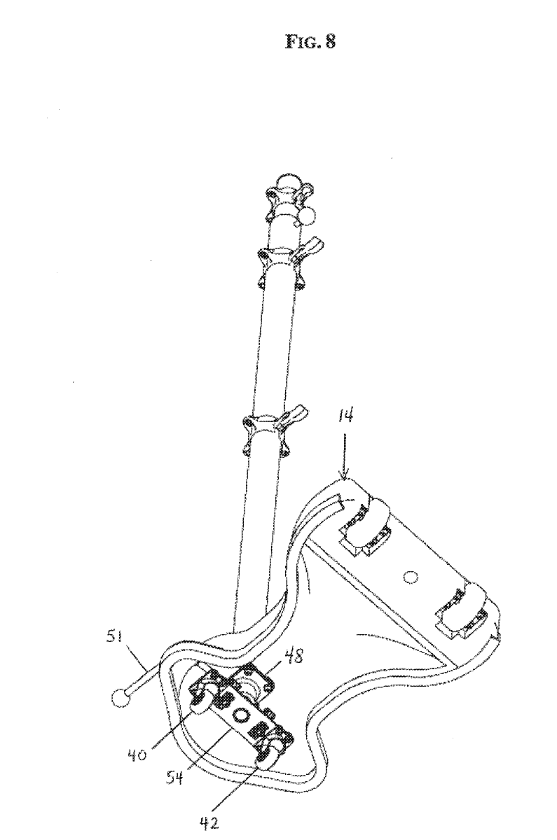

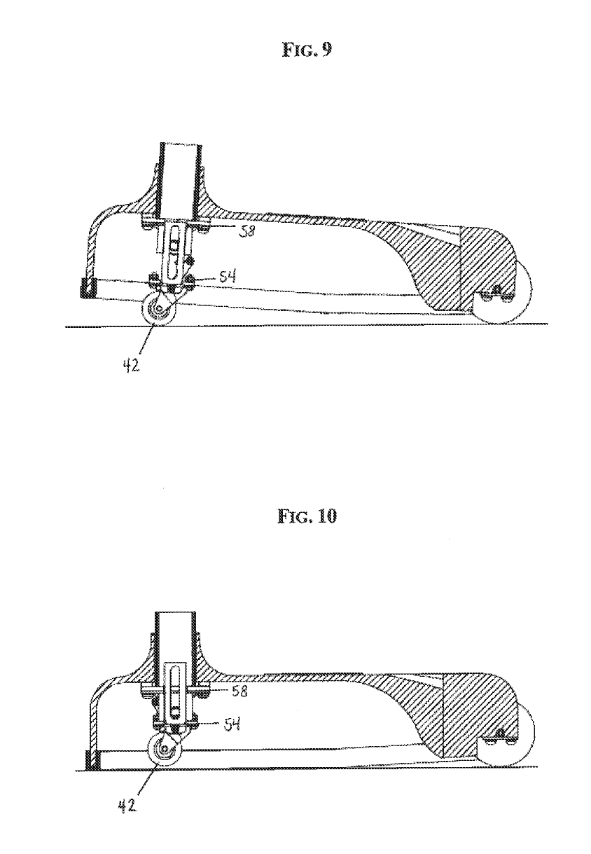

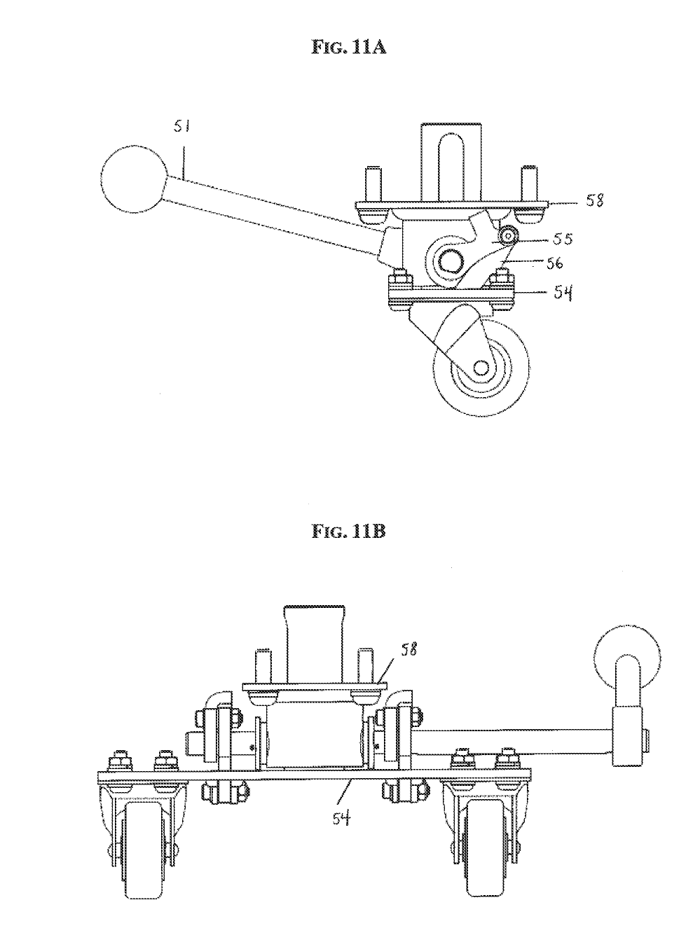

FIGS. 1-14 illustrate an exemplary embodiment of a pole support structure 10 that generally includes a pole 12 extending from a base 14. The base 14 has a center of gravity offset from a midpoint thereof to provide stability to the base 14. The base 14 also includes at least one retractable wheel coupled thereto to allow the base 14 to move along a support surface without the need to substantially tilt the base 14.

The pole 12 can have a variety of configurations, and, for example, can be in the form of an elongate rod. In an illustrated embodiment, the pole 12 has a length that allows a proximal end 12p of the pole 12 to be coupled to the base 14, while the distal end 12d of the pole 12 is far enough away from the base 14 to allow for various types of activities and/or games to be played by attaching various apparatus to the pole 12 of the pole support structure 10. The proximal end 12p of the pole 12 can be coupled to the base 14 in a variety of ways. For example, the pole 12 can be integral with the base 14, or the pole 12 can be a separate component and can be coupled thereto. In one embodiment, the base 14 can include an opening formed therein for receiving the proximal end 12p of the pole 12, and a locking mechanism can be configured to lock and unlock the pole 12 relative to the base 14. The pole 12 can be coupled to the base 14 in a variety of way, including being coupled to a top surface of the base 14, or coupled to a bottom surface of the base 14 such that any locking mechanism used to couple the pole 12 to the base 14 can be located on the bottom surface of the base 14. The pole 12 can be made from a variety of materials that have properties sufficient to enable the pole 12 to have enough strength to remain substantially upright during various activities and/or game play. For example, the pole 12 can be formed from aluminum that is made of stock that has the necessary properties for game play, such as strength and resilience.

The pole 12 can also be a single unitary pole, or the pole 12 can be formed from multiple poles coupled together. In the illustrated embodiment, the pole 12 is formed from a first pole 16 and a second pole 18. Each of the first and second poles 16, 18 are in the form of elongate rods, for example, having a cylindrical shape, and can be either solid or hollow with a inner lumen therein, although at least a portion of the first pole 16 must be hollow to allow the first pole 16 to receive a portion of the second pole 18, as explained in more detail below. The first pole 16 has a proximal end 16p that is coupled to the base 14 and a distal end 16d that is removably coupled to a proximal end 18p of the second pole 18. The diameter D₁ of the first pole 16 is greater than the diameter D₂ of the second pole 18 such that an inner lumen extending through at least a portion of the first pole 16 can receive at least a portion of the second pole 18. This allows at least a portion of the second pole 18 to slide through the inner lumen of the first pole 16 such that the length of the pole 12 can be adjusted. In addition, the second pole 18 can be removed from the lumen of the first pole 16 such that the length of the pole 12 will be equal to the length of the first pole 16. Thus, the length of the pole 12 is adjustable between a length that equals the length of the first pole 16 to a length that equals the length of the first pole 16 and substantially the length of the second pole 18, as at least a portion of the second pole 18 will remain inside the lumen of the first pole 16 to allow the first and second poles 16, 18 to be removably coupled together.

The first and second pole 16, 18 can be coupled together in a variety of ways. In the illustrated embodiment, the first pole 16 and the second pole 18 are coupled together using a pin 20 that can be inserted through pairs of openings formed in the first and second poles 16, 18. While the first pole 16 can include one or more pairs of openings formed along the length thereof to allow for increased flexibility in adjusting the length of the pole 12, in the illustrated embodiment the first pole 16 includes a single pair of openings 21 formed just proximal of the distal end 16d of the first pole 16. While the second pole 18 can also include one or more pairs of openings formed along the length thereof, in the illustrated embodiment the second pole 18 includes a first pair of openings 22 formed near the proximal end 18p of the second pole 18 and a second pair of openings 23 formed near the distal end 18d of the second pole 18. To couple the first pole 16 to the second pole 18, the pair of openings 21 of the first pole 16 is aligned with either the first or second pair of openings 22, 23 of the second pole 18 such that the pin 20 can be inserted through the openings in both the first and second poles 16, 18, thereby removably coupling the first pole 16 and the second pole 18 together.

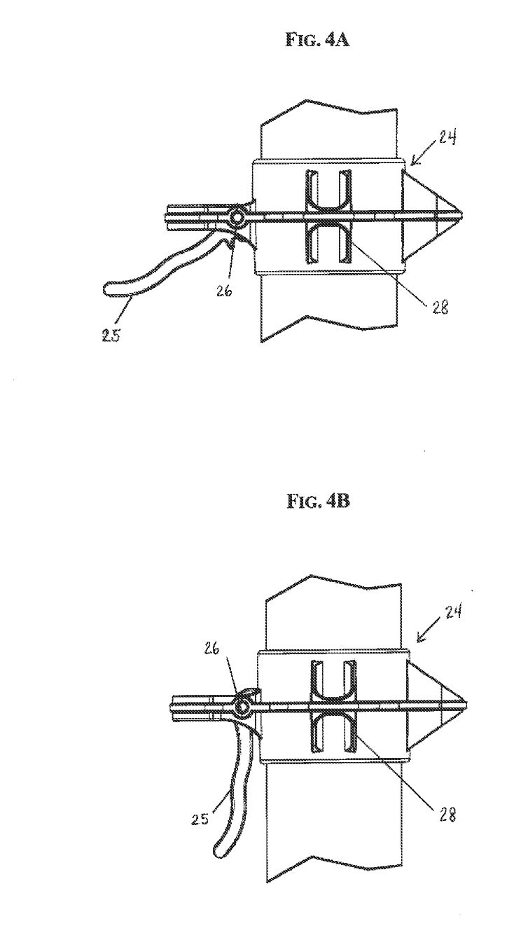

The pole 12 can also include features to allow equipment to be coupled to the pole 12 for use in game play, such as a net. FIG. 4 illustrates one embodiment of a collar 24 that is slidably and removably coupled to the pole 12 for attaching a net or other equipment to the pole 12. The collar 24 is in the form of a cylinder with a lumen extending therethrough for receiving the pole 12. The collar 24 includes a lever 25 that is attached to the collar at a pivot point 26 such that the lever 25 can be moved between an open position and a closed position. When the lever 25 is in an open position as shown in FIG. 4A, the collar 24 is slidable along the pole 12 to allow the position of the collar 24 to be adjusted along the length of the pole 12. When the lever 25 is in a closed position as shown in FIG. 4B, the collar 24 is fixed relative to the pole 12 to prevent the collar 24 from sliding and to allow an activity to be played using an apparatus connected to the collar 24, such as a net. The collar 24 includes features to allow an apparatus to be connected thereto. For example, the collar 24 can include one or more hooks 28 formed thereon to allow an apparatus to be removably coupled thereto. The collar 24 can include any number of hooks 28 or other attachment mechanisms as needed to attach the various types of apparatus thereto. In addition, the pole 12 can include any number of collars 24 along the length thereof as needed to attach the various types of apparatus to play various types of games/activities.

The base 14, as explained above, provides support for the pole 12. The base 14 can have a variety of configurations, including a variety of sizes and shapes, to provide support to the pole 12. In the illustrated embodiment, the base 14 includes a top surface 30 through which the pole 12 can extend in an upright position such that the pole 12 can be coupled to the base 14, a bottom surface 32 that sits on a support surface, a front end 34, and a back end 36. As shown in FIG. 5, the base 14 has a shape with a wider profile at the front and back ends 34, 36 than in the middle of the base 14. This shape provides lateral stability to the base, and also can allow for an offset center of gravity of the base 14. The base 14 can be made from a variety of materials that have properties sufficient to enable the base 14 to properly support the pole 12. For example, the base 14 can be formed from cast iron or cast aluminum. The base 14 can also have a variety of weights as long as the weight of the base 14 is sufficient to support the pole 12 and/or lateral loading transferred through the pole 12. For example, the base 14 can have a weight of approximately 155 lbs.

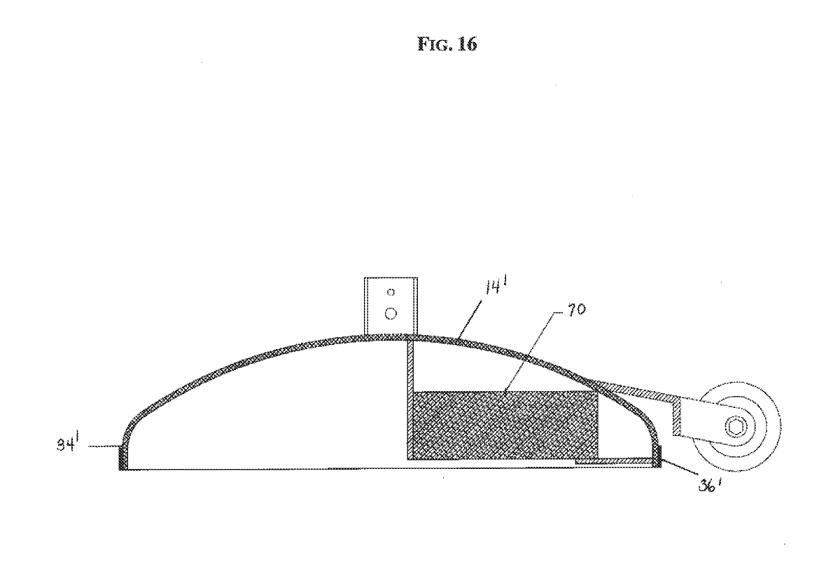

The base 14 can include features to allow the base 14 to provide the necessary stability such that the pole 12 is supported and the bottom surface 32 of the base 14 remains substantially on the support surface. The base can provide stability, for example, to resist a tension or tipping load imparted on the base 14 and the pole 12 by any equipment or other devices coupled to the pole 12 for game play or other activities. For example, the center of gravity of the base 14 can be such that the base 14 provides stability to the pole support structure 10. In one embodiment, the base 14 can have a center of gravity that is offset to increase the stability of the base 14 and the pole support structure 10, for example, to withstand tension applied to apparatus or equipment that are attached to the pole for game play. As such, the pole 12 is positioned offset from the midpoint of the base 14. In the illustrated embodiment, the pole 12 is coupled to the base 14 at a location closer to the front end 34 of the base 14 than the back end 36 of the base 14, and the center of gravity of the base 14 is such that it is offset from the location at which the pole 12 is coupled thereto. For example, the pole 12 can be offset from the center of gravity of the base 14 by approximately 18 inches. This positioning of the pole 12 relative to the center of gravity of the base 14 can have the effect of increasing the ballast effect of the base 14. The size and shape of the base 14 can also vary to provide stability to the pole support structure 10. In one embodiment, as shown in FIG. 5, the back end 36 of the base 14 has a width that is greater than the width of the front end 34 of the base 14. This configuration allows the back end 36 of the base to provide lateral stability to the pole support structure 10. In another embodiment, the distribution of weight of the base 14 can vary along its length to shift the center of gravity of the base 14 and provide support to the pole support structure 10. For example, as shown in FIGS. 15-16, a back end 36′ of a base 14′ can be made to weigh more than a front end 34′ of the base 14′, shifting the center of gravity of the base 14 towards the back end 36′ of the base 14′ and allowing the back end 36′ of the base 14′ to provide lateral stability thereto. This can be accomplished through the use of a counterweight 70 positioned in the base, as shown in FIG. 16. The weight of the base 14′ can vary by using different materials for different portions of the base 14′, or the base 14′ can include a reservoir or opening formed therein to receive a material having the proper weight to achieve the desired weight distribution. It will be appreciated, however, that the center of gravity of the base 14′ can also be shifted towards the front end 34′ of the base 14′. It will also be appreciated that shifting the center of gravity using varying weights can also be achieved using the base 14, and that the various methods described above to shift the center of gravity of the base 14 can also be used with the base 14′ or a base or any shape.

The bottom surface of the base 14 can also include features to provide stability to the base 14. For example, the bottom surface can be formed such that the surface area of the bottom surface that contacts the support surface is maximized. The maximized surface area of the bottom surface of the base 14 can help to support the base 14 and the pole 12, and can help resist sliding of the base when the at least one retractable wheel is in the retracted position and the base 14 is fixed relative to the support surface, as will be discussed in more detail below. The bottom surface of the base can also include additional features to resist sliding along the support surface, including a friction mechanism, such a rubber trim coupled to the bottom surface. The friction mechanism can help prevent the base from sliding on the support surface and can also protect the support surface.

The base 14 (and the base 14′) also includes features to allow the base 14 to move along the support surface. While a variety of mechanisms can be used to move the base 14, the base 14 can include a variety of wheels to allow the base 14 to move along the support surface. The base 14 can also include features to allow the base to be in a locked position such that the base 14 cannot move relative to a support surface, and an unlocked position in which the base 14 can be moved along the support surface.

In one embodiment, the base 14 includes one or more wheels coupled thereto to allow the base to move along the support surface, and at least one of the wheels is configured to be retractable such that the wheel can move between a retracted position in which the base is fixed relative to the support surface and an extended position in which the wheel is used to move the base along the support surface. The base 14 can include any number of retractable wheels. The base 14 can also optionally include one or more wheels that are fixed relative to the base 14 to allow for an increase in the ease of movement and stability of the base 14 when the one or more retractable wheels are in the extended position, which will be discussed in more detail below. It will be appreciated that any number of retractable wheels and optional fixed wheels can be coupled to the base to move the base along a support surface as long as the base is fixed relative to the support surface when at least one of the retractable wheels is in the retracted position. The wheels can also be spaced on the base in such a way to provide lateral stability to the base.

In the illustrated embodiment, the base 14 includes first and second retractable wheels 40, 42 coupled thereto such that the base 14 is fixed relative to a support surface when the retractable wheels 40, 42 are in the retracted position and the base 14 is movable relative to the support surface along the retractable wheels 40, 42 when the retractable wheels 40, 42 are in an extended position and touching the support surface. It can be appreciated, however, that any number of retractable wheels can be used to effect movement of the base 14 relative to the support surface. In the illustrated embodiment, the base 14 also includes two fixed wheels. When the base 14 is locked relative to the support surface, the retractable wheels 40, 42 do not contact the support surface, but the fixed wheels do contact the support surface in both the fixed and movable positions. Thus, when the base 14 is fixed relative to the support surface, at least a portion of the base 14 is raised off of the support surface due to the presence of the fixed wheels. For example, approximately ⅓ of the base 14 can be raised off of the support surface.

The bottom surface 32 of the base 14 can have a variety of configurations to accommodate the retractable wheels 40, 42 such that the base 14 cannot move along the support surface when the retractable wheels 40, 42 are in the retracted position. In one embodiment, the bottom surface 32 of the base 14 includes a recess formed therein that is at least large enough for the retractable wheels 40, 42 to fit therein. This allows the base 14 to lay substantially flat against the support surface when the retractable wheels 40, 42 are in the retracted position. In the illustrated embodiment, the bottom surface 32 of the base 14 includes a recess 48 formed therein that forms a rim 50 around substantially all of the outer edge of the base 14. The rim 50 is configured to contact the support surface, and a recess 48 is formed within the rim. It will be appreciated, however, that the recess need only be large enough to house the retractable wheels and the mechanism by which the retractable wheels are moved between the retracted and extended positions. The retractable wheels 40, 42 are coupled to the bottom surface 32 of the base 14 such that substantially all of the rim 50 of the bottom surface 32 of the base 14 lays flat against the support surface and the wheels are fully retracted into the recess 48 formed in the bottom surface 32 of the base 14.

The first and second retractable wheels 40, 42 can be coupled to the base 14 and moved between the retracted and extended positions in a variety of ways, and an actuation mechanism can be used to effect movement of the retractable wheels 40, 42 between the retracted and extended positions. A single actuation mechanism can be used to move the first and second retractable wheels 40, 42 simultaneously, as shown in the illustrated embodiment, or each of the first and second retractable wheels 40, 42 can be coupled to its own actuation mechanism. Any number of retractable wheels and actuation mechanisms can be used in any combination as long as each retractable wheel is capable of being moved between the retracted and extended positions.

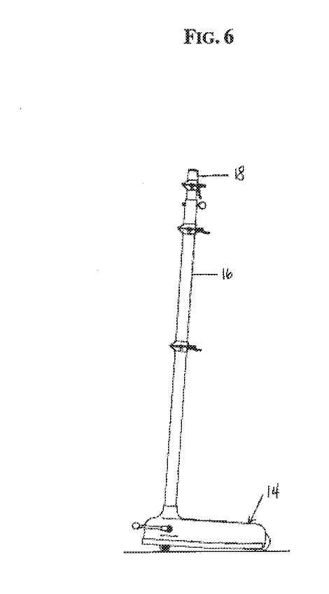

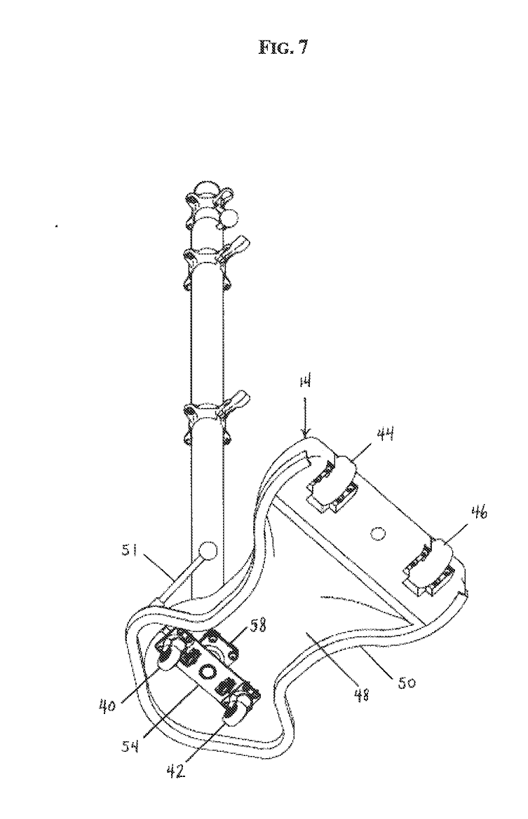

As indicated above, an actuation mechanism is used to effect movement of the retractable wheels 40, 42 between the retracted position in which the base 14 is fixed relative to the support surface and the extended position in which the base 14 is movable relative to the support surface. In one embodiment shown in FIGS. 7-8, the actuation mechanism is in the form of a lever 51 that is coupled to the base 14 and the first and second retractable wheels 40, 42. The lever 51 is coupled to the base 14 with a shaft 52 that extends through the base 14. The first and second retractable wheels 40, 42 are mounted to a first support plate 54. The first support plate 54 is coupled to an assembly configured to move the wheels 40, 42. The other end of the assembly is coupled to the bottom surface of the base 14 with a second support plate 58. It can be appreciated that the assembly can also be coupled directly to the bottom surface of the base 14. When the retractable wheels 40, 42 are moved to the extended position, the lever 51 moves the assembly such that it effectively increases the distance between the bottom surface of the base 14 and the retractable wheels 40, 42 such that the wheels 40, 42 contact the support surface to allow the base 14 to move therealong. It should be appreciated, however, that any actuation mechanism can be used to move the retractable wheels between the retracted and extended positions.

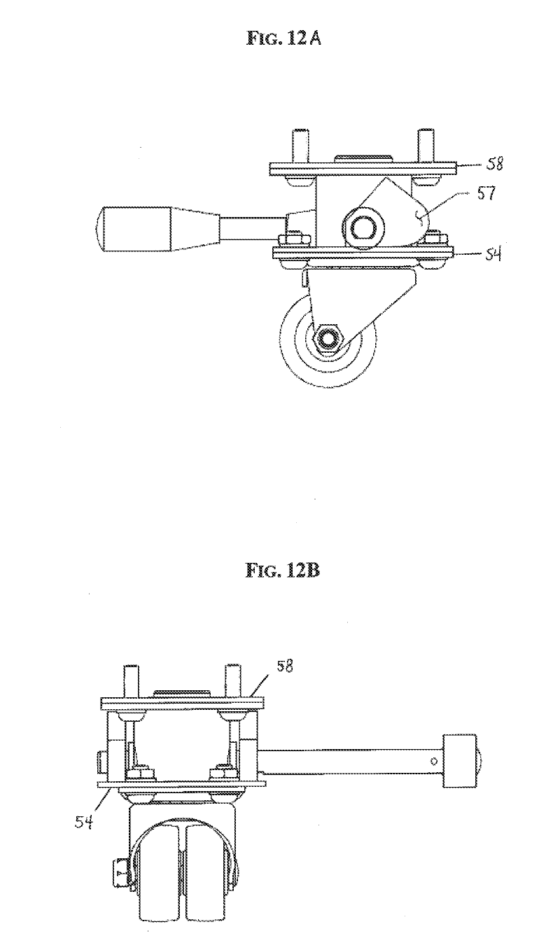

The assembly that moves the wheels can have a variety of configurations. In one embodiment shown in FIGS. 9-11B, the assembly is in the form of a series of linkages that are coupled to the first and second support plates 54, 58. In the illustrated embodiment, there is a first linkage 55 and a second linkage 56. The first linkage 55 has a distal end that is coupled to the second support plate 58 and a proximal end that pivotally engages a distal end of the second linkage 56. A proximal end of the second linkage 56 couples to the first support plate 54. The shaft 52 of the lever 51 is coupled to the first linkage, and pivoting the lever 51 is effective to move the first and second linkages such that when the retractable wheels 40, 42 are in the retracted position, the second linkage is positioned substantially alongside the first linkage. In another embodiment shown in FIGS. 12A-12B, the assembly is in the form of a cam 57 that is configured to rotate upon movement of the lever 51 to move the wheels between the retracted and extended positions. It can be appreciated that many other types of assemblies can be used to move the retractable wheels, for example, a telescoping assembling that includes multiple rods that are configured to slide within one another to move the retractable wheels.

As explained above, the base 14 can also include one or more fixed wheels coupled thereto. In the illustrated embodiment, the base includes first and second fixed wheels 44, 46. The fixed wheels 44, 46 can be a variety of types of wheels. For example, the fixed wheels can be in the form of swivel wheels to allow the base to have a tight turning radius around the first wheels. The fixed pair of wheels can also be coupled to the base in a variety of ways. For example, the base can include a rod in, for example, the first end of the base 14 such that the fixed wheels can be threaded on the rod through openings formed in the fixed wheels such that the wheels can rotate around the rod, as illustrated in FIGS. 7-8, or the fixed wheels can be in the formed of casters that are coupled to the bottom surface of the base with various attachment mechanisms, such as screws. The distance between the fixed wheels can also vary, and can be chosen to provide additional stability to the base 14. For example, the fixed wheels can be positioned at a maximum distance from each other as allowed by the width of the base 14.

The position of the various wheels coupled to the base 14 can also vary, and can be chosen to increase the stability of the base 14 and the pole support structure 10. The base 14 includes enough wheels positioned in such a way as to allow the base 14 to move along the support surface when the retractable wheels are in the extended position. For example, the base 14 can include a first pair of wheels positioned in a location between the first end 34 of the base 14 and a midpoint of the base 14, and a second pair of wheels positioned between the second end 36 of the base 14 and the midpoint of the base 14 to allow for stability when the retractable wheels are extended and the base 14 is moving along a support surface on the wheels. In illustrated embodiment, the base 14 includes a first pair of wheels, the fixed wheels 44, 46, positioned at the first end 34 of the base 14 and a second pair of wheels, the retractable wheel 40, 42, positioned at the second end 36 of the base 14. The fixed wheels 44, 46 are coupled to the base 14 such that the first end 34 of the base 14 is raised slightly off of the support surface, even when the retractable wheels 40, 42 are in the retracted position. Thus, when the retractable wheels 40, 42 are moved from the retracted position to the extended position, the retractable wheels 40, 42 contact the support surface and the second end 36 of the base 14 is also raised slightly off of the support surface to allow the base 14 to move therealong. For example, the second end 36 can be raised off of the support surface a distance in the range of 1 inch to 2.5 inches, allowing the base 14 to clear the threshold of a doorway. It will be appreciated, however, that both pairs of wheels can be retractable wheels, and the base can be raised off of the support surface any distance as would be required. In addition, it can be appreciated that the retractable wheels can be positioned at the first end of the base, and the fixed wheels can be positioned at the second end of the base.

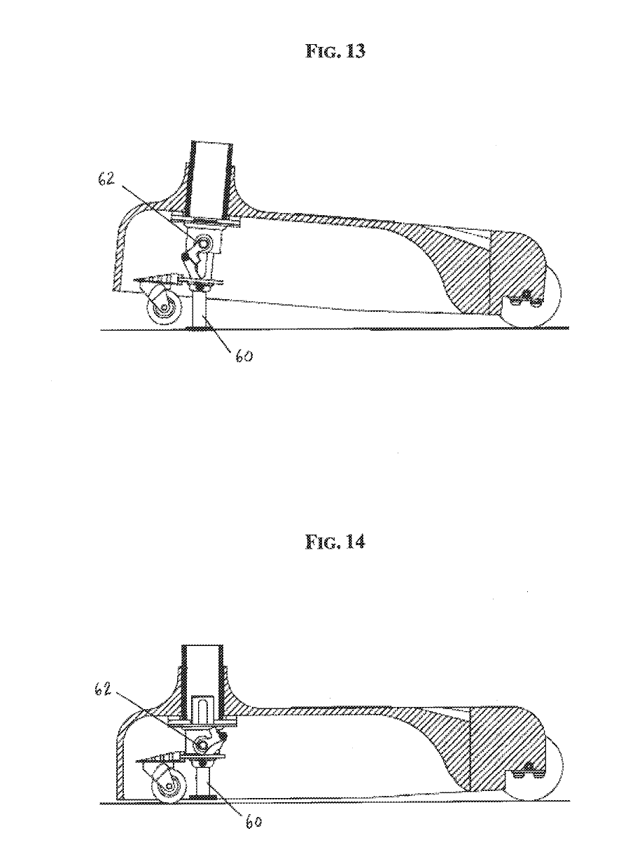

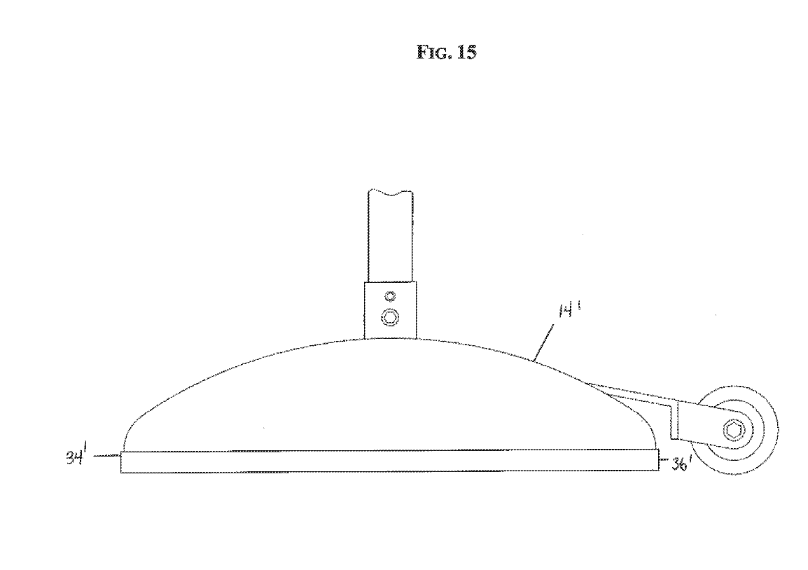

In another embodiment, the base 14 can include an anti-roll mechanism that prevents the wheels coupled to the base from rolling along the support surface. For example, in the illustrated embodiment of FIGS. 13-14, the anti-roll mechanism is in the form of a retractable foot 60 that is movably coupled to the base 14 to allow the base 14 to be in a locked position when the foot 60 is extended from the base as shown in FIG. 13, and an unlocked position when the foot 60 is retracted off of the support surface as shown in FIG. 14. The retractable foot 60 can be movably coupled to the base in a variety of ways, but in the illustrated embodiment the retractable foot 60 is coupled to the base using a linkage mechanism that can move the retractable foot using an actuation mechanism, such as a lever that can be coupled to the linkage mechanism at a pivot point 62. When the retractable foot 60 is extended from the base, as shown in FIG. 13, the wheels at the front end of the base are disengaged from the support surface and the base is locked relative to the support surface. When the retractable foot 60 is retracted into the base, as shown in FIG. 14, the wheels at the front end of the base engage the support surface and the base can be moved relative to the support surface on the wheels at the front and back ends of the base. In another embodiment, the anti-roll mechanism is in the form of a locking device coupled to the wheels. The locking device can move between a locked position in which the locking device engages the wheels to prevent the base from moving relative to a support surface, and an unlocked position in which the locking device disengages from the wheels to allow the base to move along the support surface. The locking device can have a variety of configurations as long as the locking device can move to engage and disengage the wheels.

In use, the base can be fixed relative to the support surface when the retractable wheels are in the retracted position and seated within the recess formed in the bottom surface of the base. To allow the base to move along the support surface, the actuation mechanism, i.e. the lever, can be actuated to cause the retractable wheel to move into the extended position such that the retractable wheels extend out of the recess formed in the bottom surface of the base and contact the support surface. In this position, the base can move along the support surface on the retractable wheels and the fixed wheels.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus, comprising:
a pole having a first end and a second end, the pole being configured to support one or more gaming apparatus; and
a base being configured to support the pole to hold the pole in an upright position, the base having a front end and a back end, the base being configured to receive the first end of the pole such that the pole is positioned closer to the front end of the base than the back end of the base, and the base having a center of gravity that is closer to the back end than the front end such that the back end of the base provides lateral stability to the base.

2. The apparatus of claim 1, wherein the first end of the base has a width greater than the second end of the base to provide the lateral stability to the base.

3. The apparatus of claim 1, wherein the first end of the base has a weight greater than the second end of the base to provide lateral stability to the base.

4. The apparatus of claim 1, wherein the base further includes at least one retractable wheel coupled thereto such that the retractable wheel is configured to move between a retracted position in which the base is fixed relative to a support surface, and an extended position in which the base is movable relative to the support surface.

5. The apparatus of claim 4, wherein the base includes an actuation mechanism movably coupled to the retractable wheel such that the actuation mechanism is adapted to effect movement of retractable wheel between the retracted and extended positions.

6. The apparatus of claim 5, wherein the actuation mechanism is in the form of a lever movably coupled to the retractable wheel such that pivoting the lever effects movement of retractable wheel between the retracted and extended positions.

7. The apparatus of claim 4, wherein the base further includes at least fixed wheel having a position on the base that is fixed relative thereto.

8. The apparatus of claim 7, wherein the fixed wheel is positioned at substantially the first end of the base and the retractable wheel is positioned at substantially the second end of the base.

9. Apparatus, comprising:
a base having a pole extending therefrom, the pole being configured to extend from the base in an upright position and to support one or more gaming apparatus;
a first set of wheels extending from the base, the first set of wheel between retractable between a retracted position in which the base is fixed relative to a support surface, and an extended position in which the base is movable relative to the support surface; and
a second set of wheels extending from the base.

10. The apparatus of claim 9, where the base includes an actuation mechanism movably coupled to the retractable wheel such that the actuation mechanism is adapted to effect movement of retractable wheel between the retracted and extended positions.

11. The apparatus of claim 9, wherein the base includes a first end and a second end, and the center of gravity of the base is closer to the first end than the second end such that the first end provides lateral stability to the base.

12. The apparatus of claim 11, wherein the first end of the base has a width greater than the second end of the base to provide the lateral stability to the base.

13. A method, comprising:
extending at least one retractable wheel coupled to a base such that the at least one retractable wheel moves from a retracted position in which the retractable wheel is contained within the base to an extended position in which at least a portion of the retractable wheel extended from the base; and
moving the base along the at least one retractable wheel when the retractable wheel is in the extended position such that the base is movable along a support surface without tilting the base.

14. The method of claim 13, wherein extending the retractable wheel comprising actuating an actuation mechanism to move the retractable wheel from the retracted position to the extended position.
